(19) United States
(12) Patent Application Publication
(10) Pub. No.: US 2009/0091936 A1
(43) Pub. Date: Apr. 9, 2009

(54) Focal point projection light signal comprising a beam concentrator

(76) Inventor: George H. Koester, Jacksonville, FL (US)

Correspondence Address: ROGERS TOWERS, P.A., 1301 RIVERPLACE BOULEVARD, SUITE 1500, JACKSONVILLE, FL, 32207, US

(21) Appl. No.: 12/287,097

(22) Filed: Oct. 6, 2008

Related U.S. Application Data
(60) Provisional application No. 60/997,585, filed on Oct. 4, 2007.

(51) Int. Cl. F21V 13/04

(52) U.S. Cl. 362/309; 362/308

(57) ABSTRACT

An improved focal point projection light signal device having a single point light source, a Fresnel lens, and a reflective beam concentrator having a spherical reflective surface located to the rear of the light source. The single point light source is positioned at the focal point of the Fresnel lens such that light emitted toward the Fresnel lens is refracted into a concentrated beam pattern that is projected from the front of the lens. The reflective surface of the beam concentrator is spherically concave and is positioned such that light emitted to the rear of the light bulb is reflected back through the lens focal point and out through the Fresnel lens. The overall diameter of the reflective beam concentrator is significantly smaller than the diameter of the Fresnel lens such that reflection of extraneous light sources that may produce phantom signal indications is minimized.

This patent application claims the benefit of U.S. Provisional Patent Application Ser. No. 60/997,585, filed Oct. 4, 2007, the disclosure of which is incorporated herein by reference.

### BACKGROUND OF THE INVENTION

This invention relates generally to the field of projecting light signals, i.e., devices that project a beam of light, often colored, such that the light can be perceived a significant distance from the device. More particularly, this invention relates to focal point projection light signals, wherein the light emitting from a single point light source, such as the filament of an incandescent bulb, passes through a Fresnel or similar lens, which focuses the emitted light into a projected beam pattern for maximum visibility for the specific application.

Projecting light signals are well known, and are designed such that light emitted from a light source is concentrated, focused or otherwise controlled such that the lighting device projects a beam of light of greater intensity than the light projected in a given direction by the light source alone. Because of the projected light beam, the color or clear light signal can be perceived a significant distance from the light source. One industry in which projected color light signals are extensively used is the railroad industry, where the color light signals are used to direct train engineers in controlling their trains for safe operations as they are approaching or passing wayside train control signals and other railroad crossings at grade, or other similar train movements involving a train control signal aspect.

Since the advent of color light signal for train control applications, there has been an effort to make the illuminated color as bright and visible as possible with a projected beam pattern to maximize safe train operations. Now, possibly more that ever, with larger and heavier trains, and with goals of improving train travel time and improving safer train operations, there is a need to have train control signals that have greater projected beam patterns, permitting train crews to identify illuminated color signal displays as far as possible from the signals so train crews have more reaction time for train handling safety, plus reducing fuel consumption and mechanical wear associated with abnormally hard train braking applications to comply with displayed color signal aspects.

The two major generic signal lights used for train control operations are the focal point projection light, often referred to in the industry as a color light signal (CLS), and a parabolic reflector light, often referred to as a searchlight signal. When comparing these two items, searchlight signals, because of their large parabolic reflectors, have more projected beam candlepower than color light signals. With many railroads replacing searchlight signals with color light signals because of high maintenance costs associated with the searchlight signals, because of the internal electro-mechanical mechanism to prevent possible mechanism failures that may display a false proceed signal aspect, and the fact that the color light signals are more compatible with the new programmable computer train logic controller's wiring interface that are replacing the old electro-mechanical relays logic configuration used with searchlight signals and other train control logic and equipment devices.

Train control color light signals are configured for maximizing beam candlepower projection with a single point light source (e.g., an incandescent lamp filament) and lens optics for controlling far and near beam patterns so train crews can maximize safe train handling operations. The parabolic reflectors within searchlight signals are designed to utilize as much of the light from the single light point source (lamp filament) as possible. For CLS devices, the generic duplex lens set (color inner lens and clear outer lens) is designed to utilize the optical distance of the light from the single point light source and the focal distance from the compound center and Fresnel rings of the lens set without any type of reflector or beam concentrator device.

The terminology of beam candlepower or beam lumens refers to the projected beam pattern of illumination and intensity. Searchlight signals with their parabolic reflector have the best projected beam lumens patterns when compared with CLS lighting devices. This means that a typical searchlight signal can be perceived at a greater distance with greater clarity, and that the likelihood of phantom signal indications caused by extraneous light sources are reduced. Phantom signal indications may be caused by:

1. An external light source reflecting off the outer lens appearing to make an illuminated color other than intended or obliterating the intended displayed color beyond recognition for train crews to more safely operate their trains.

2. An external light source behind the CLS device obliterating the intended displayed color beyond recognition for train crews to more safely operate their trains.

3. An external light source having penetrated the color lens set so as to make the color appear lit when not lit, causing train crews to not take appropriate train handling action for intended safe train operations.

It has been proven that the brighter the projected color beam light pattern, the more difficult it is for reflective external light, external penetrated light or background wash-out phenomena to occur. Therefore, it would be extremely beneficial to improve the intensity of the projected beam lumens pattern from the CLS devices for enhancing the projected beam pattern, thereby improving visibility from a greater distance, which would contribute to safer train operations and associated cost savings.

It is an object of this invention to provide an improved focal point projection light signal (i.e., CLS) device that has an improved beam lumens pattern of greater visibility intensity. It is an object to provide such an improved device by providing a specifically designed reflective beam concentrator that directs previously unutilized light emitted from the single point light source through the existing projecting lenses. It is a further object to provide such an improved device wherein current CLS devices can be quickly and easily in-service retrofitted by maintenance personnel without any special tools and in a timely fashion. These and other objects not expressly stated here will be apparent after review of the following disclosures.

### SUMMARY OF THE INVENTION

The invention is an improved focal point projection light signal device comprising a housing retaining a single point light source, such as the filament of an incandescent light bulb, a lens with Fresnel rings and a center compound lens, and a reflective beam concentrator located to the rear of the light bulb, the beam concentrator preferably having a base with curved projections to encircle the base of the light bulb designed so as to maintain proper focal alignment because of the mounting location on the base of the universal standard incandescent lamp. The single point light source is positioned at the focal point of the Fresnel lens such that light emitted toward the Fresnel rings and the compound portion of the lens is refracted into a concentrated beam pattern that is projected from the front of the lens. The reflective surface of the beam concentrator is spherically concave and is positioned such that light emitted to the rear of the light bulb filament is reflected back through the focal point and out through the Fresnel rings and compound center of the lens. The overall diameter of the reflective beam concentrator is significantly smaller than the diameter of the Fresnel portion of the lens such that reflection of extraneous light sources that may produce phantom signal indications is significantly minimized.

### BRIEF DESCRIPTION OF THE DRAWINGS

FIG. 1 is an illustration of one embodiment of the invention showing the reflective beam concentrator mounted onto a light bulb, in this case an S-11 lap.

FIG. 2 is a schematic illustration of the light projection pattern of a prior art focal point projection light signal device without a reflective beam concentrator.

FIG. 3 is a schematic illustration of the light projection pattern of a focal point projection light signal device with the reflective beam concentrator properly positioned.

FIG. 4 is an ISO Candela Plot of the projected beam pattern of the prior art focal point projection light signal device.

FIG. 5 is an ISO Candela Plot of the projected beam pattern of a focal point projection light signal device with the reflective beam concentrator properly positioned.

### DETAILED DESCRIPTION OF THE INVENTION

With reference to the drawings, the invention will now be described in detail with regard for the best mode and the preferred embodiment. In general, the invention is a focal point projection light signal device, often referred to as a color light signal (CLS) device, wherein a controlled and concentrated beam of preferably colored light is projected from the device in a manner that allows the signal to be perceived at a significant distance.

The focal point projection light signal device comprises a housing 11 with a non-reflecting rear surface 12. A single point light source 31, such as an incandescent light bulb or lamp for example, is positioned within the housing, which is provided with suitable electrical circuitry whereby the light source 31 can be illuminated. The filament 32 of a light bulb is commonly referred to in general in this situation and is expressly herein defined as a single point for light emission. Suitable single point light sources 31 may be for example T4 or S11 lamps, which are commonly used in the railroad industry in focal point projection light signal devices.

A refractive focal point lens 21, such as a Fresnel lens, is mounted to the front of the housing 11. The Fresnel lens 21 may comprise a single lens or a duplex lens set consisting of a color inner lens and a clear outer lens, such that the projected light beam 90 is colored, such as for example red, yellow, lunar blue or green. The refractive focal point lens 21 typically comprises a combination of concentric prism rings 22 and a central lens 23, all of which share a single focal point, such that light rays 91 emitted at broadly different angles from the focal point are refracted into a controlled pattern, such as for example substantially parallel light rays 92, depending on the specific beam pattern required, to form a controlled and intensified projected light beam 90. To create the optimum beam 90, the filament 32 of the single point light source 31 is positioned at the focal point of the lens 21.

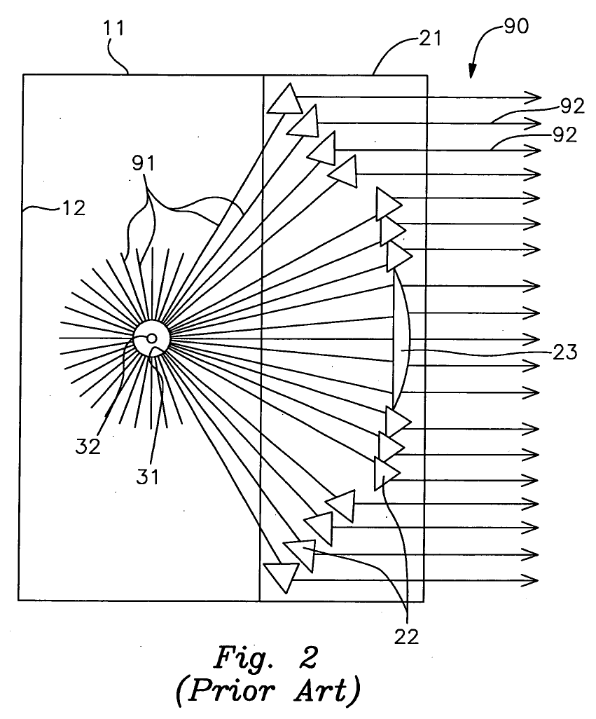

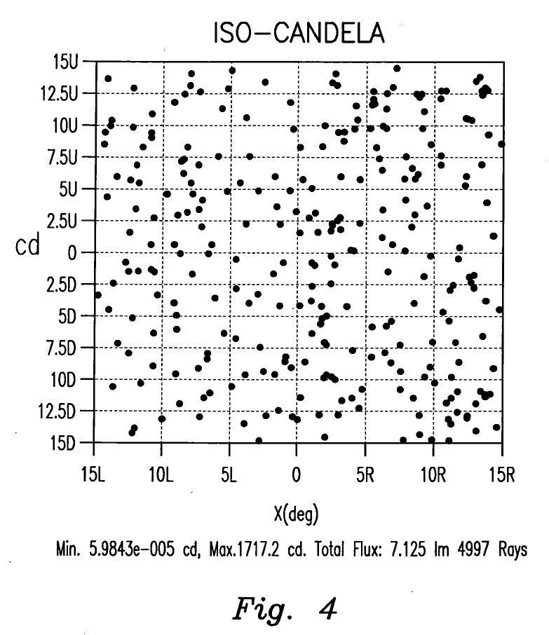

The light source 31 projects light rays 91 over a 360 degree spherical region. In the prior art focal point projection light signal devices, the majority of the emitted light rays 91 emanating from the single point light source 31 are not projected through the refractive focal point lens 21, as shown in FIG. 2. Since any light rays 91 not passing through the focal point in the direction of the lens 21 will not be properly refracted by the lens 21, most of the light from the single point light source 31 is wasted. This results in a projected beam 90 of relative low intensity, as illustrated in the projected beam pattern of FIG. 4. Because of the low intensity, such signal devices are more susceptible to phantom signal indications and are more difficult to see in poor visibility conditions, such as with fog or rain.

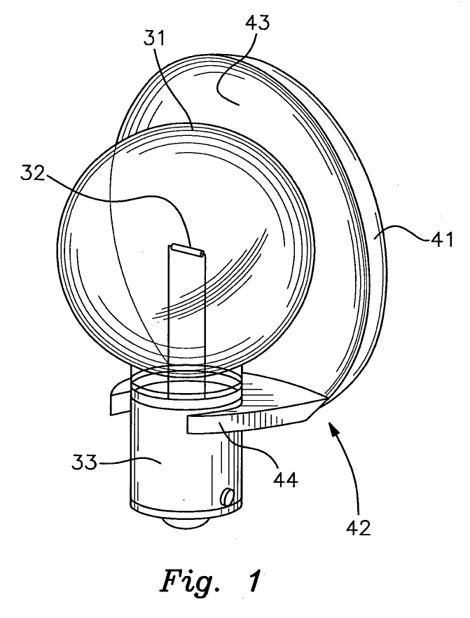

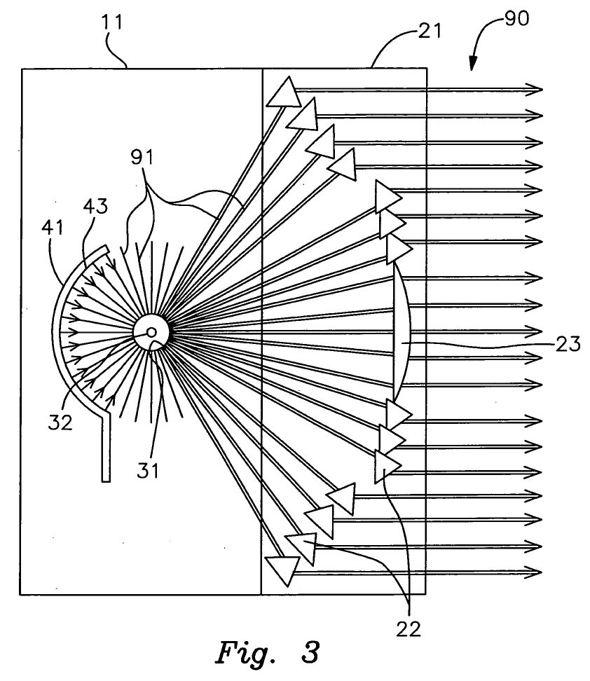

The improved focal point projection light signal device further comprises a reflective beam concentrator 41 that is positioned within the housing 11 to the rear of the single point light source 31, the beam concentrator 41 comprising a concave spherical reflective surface 43, i.e., the reflective surface 43 consisting of a portion of a sphere, and means 42 for mounting the beam concentrator onto the cylindrical base 33 of the single point light source 31. Mounting means 42 may comprise a pair of projecting arms that form a clip member 44, such that the beam concentrator 41 can be snapped or slid onto the cylindrical base 33, as shown in FIG. 1. The spherical reflective surface 43 has a focal point, and the beam concentrator 41 is positioned such that the focal point of the spherical reflective surface 43 corresponds with the focal point of the refractive lens 21 to define a common focal point for both. In other words, like that of the lens 21, the focal point of the spherical reflective surface 43 corresponds with the filament 32 of the single point light source 31. In this manner, as shown in FIG. 3, light rays 91 emitted to the rear of the filament 32 are reflected by the spherical reflective surface 43 directly back through the focal point of the refractive lens 21, such that these reflected light rays 91 will be properly refracted by the lens 21 into the projected beam 90.

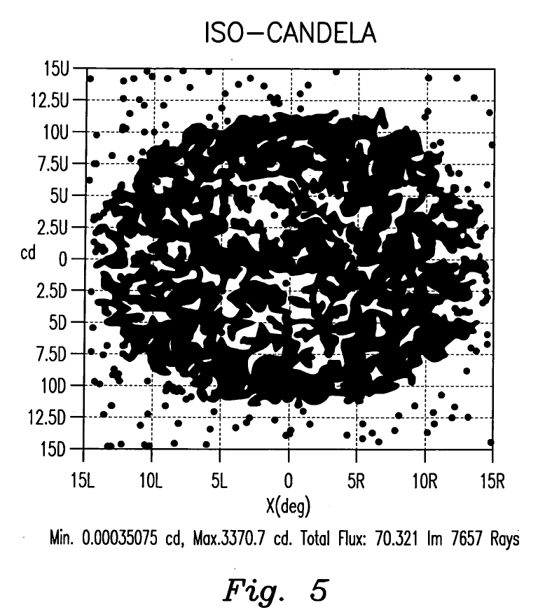

This results in a greatly intensified projected light beam 90, as illustrated in FIG. 5. For example, in a standard focal point projection light signal device that captures emitted light rays 91 over a conical projection zone covering approximately 120 degrees, as is shown in FIG. 2, approximately 240 degrees of emitted light 91 is not projected by the device and is essentially wasted. Conversely, with the beam concentrator 41 properly positioned as in FIG. 3 such that the focal point of the reflective surface 43 and the focal point of the refractive lens 11 correspond, approximately 120 degrees of the emitted light 91 originally directed rearward is reflected back through the focal point and onto the lens 21. Thus, approximately 240 degrees of emitted light 91 is refracted into the projected beam 90 and only approximately 120 degrees of emitted light is unused, resulting in significantly increased signal visibility intensity.

It is critical that the diameter of the spherical reflective surface 43 be relatively small in relation to the diameter of the refractive lens 21, preferably being less than approximately half the diameter of the refractive lens 21, and more preferably being about one third the diameter of the lens 21 in order to balance the need to maximize reflective properties while simultaneously minimizing adverse reflective effects from external light sources. It is desirable to keep the size of the spherical reflective small so that only a relatively small amount of or none of any extraneous light that may enter the housing 11 through the refractive lens 21 is reflected back through the refractive lens 21, thus minimizing the chance of phantom signal indications being perceived. If the spherical reflective is too large, phantom signal indications may occur. The small size of the reflective surface 43, coupled with its spherical shape, thereby avoids one of the major problems associated with the larger concaved reflectors used in light signals. Furthermore, again in contrast to the searchlight signals having parabolic reflectors, the physical presence of the beam concentrator 41 blocks most of any extraneous light that may reflect back from the non-reflecting rear 12 of the housing 11 that may cause the lens 21 to glow internally, thereby generating a phantom signal indication.

It is contemplated that equivalents and substitutions for certain elements set forth above may be obvious to those of ordinary skill in the art, and therefore the true scope and definition of the invention is to be as set forth in the following claims.

I claim:

1. A focal point projection light signal comprising:
a housing having a non-reflective internal rear surface;
a refractive focal point lens mounted to said housing, said lens having a diameter and a focal point whereby light emitted from said focal point passing through said lens is refracted into a projected beam pattern;
a single point light source mounted within said housing, said light source having a filament positioned at said focal point of said lens;
a beam concentrator mounted within said housing, said beam concentrator comprising a concave spherical reflective surface having a diameter, whereby a portion of light emitted from said light source in a direction away from said lens is reflected back through said focal point onto said lens and is refracted into said projected beam pattern;
wherein the diameter of said concave spherical reflective surface is less than half the diameter of said lens.

2. The light signal of claim 1, wherein said concave spherical reflective surface is approximately one third the diameter of said lens.

3. The light signal of claim 1, wherein approximately 120 degrees of said light emitted from said light source in a direction away from said lens is reflected back.

4. The light signal of claim 1, wherein said lens is a Fresnel lens comprising a plurality of concentric prism rings.

5. The light signal of claim 4, wherein said Fresnel lens further comprises a central compound lens.

6. The light signal of claim 1, wherein said light source comprises an incandescent lamp having a cylindrical base, and wherein said beam concentrator further comprises means for mounting the beam concentrator onto said base of said light source.

7. The light signal of claim 6, wherein said mounting means comprises a pair of projecting arms grasping said base.

8. A focal point projection light signal comprising:
a housing;
a refractive focal point lens mounted to said housing, said lens having a diameter and a focal point whereby light emitted from said focal point in the direction of said lens passes through said lens and is refracted into a projected beam pattern;
a single point light source mounted within said housing, said light source having a filament positioned at said focal point of said lens;
a beam concentrator mounted within said housing such that said light source is positioned between said lens and said beam concentrator, said beam concentrator comprising a concave spherical reflective surface having a focal point and a diameter, said beam concentrator being mounted such that said concave spherical reflective surface focal point and said lens focal point correspond so as to define a common focal point, whereby light emitted from said light source striking said concave spherical reflective surface is reflected back through said common focal point onto said lens and is refracted into said projected beam pattern in addition to said light emitted in the direction of said lens;
said diameter of said concave spherical reflecting surface being less than half the diameter of said lens;
said beam concentrator blocking light passing through said lens from an external light source and reflecting off said housing from passing back through said common focal point and being projected out through said lens.

9. The light signal of claim 8, wherein said concave spherical reflective surface is approximately one third the diameter of said lens.

10. The light signal of claim 8, wherein approximately 120 degrees of said light emitted from said light source in a direction away from said lens is reflected back.

11. The light signal of claim 8, wherein said lens is a Fresnel lens comprising a plurality of concentric prism rings.

12. The light signal of claim 11, wherein said Fresnel lens further comprises a central compound lens.

13. The light signal of claim 8, wherein said light source comprises an incandescent lamp having a cylindrical base, and wherein said beam concentrator further comprises means for mounting the beam concentrator onto said base of said light source.

14. The light signal of claim 13, wherein said mounting means comprises a pair of projecting arms grasping said base.

15. A focal point projection light signal comprising:
a housing;
a refractive focal point lens mounted to said housing, said lens having a diameter and a focal point whereby light emitted from said focal point in the direction of said lens passes through said lens and is refracted into a projected beam pattern, said lens being a Fresnel lens comprising a plurality of concentric prism rings and a central compound lens;
a single point light source mounted within said housing, said light source comprising an incandescent lamp having a filament positioned at said focal point of said lens and a cylindrical base;
a beam concentrator mounted within said housing such that said light source is positioned between said lens and said beam concentrator, said beam concentrator comprising a concave spherical reflective surface having a focal point and a diameter, said beam concentrator being mounted such that said concave spherical reflective surface focal point and said lens focal point correspond so as to define a common focal point, whereby light emitted from said light source striking said concave spherical reflective surface is reflected back through said common focal point onto said lens and is refracted into said projected beam pattern in addition to said light emitted in the direction of said lens, and wherein approximately 120 degrees of said light emitted from said light source in a direction away from said lens is reflected back;
said diameter of said concave spherical reflecting surface being approximately one third the diameter of said lens;
said beam concentrator blocking light passing through said lens from an external light source and reflecting off said housing from passing back through said common focal point and being projected out through said lens;
and said beam concentrator further comprising means for mounting the beam concentrator onto said base of said light source comprising a pair of projecting arms grasping said base, whereby said beam concentrator may be snapped or slid onto said base.
